(19) United States
(12) Patent Application Publication
(10) Pub. No.: US 2006/0012073 A1
(43) Pub. Date: Jan. 19, 2006

(54) Extrusion molding apparatus and extrusion molding method

(75) Inventors: Yasunao Miura, Nagoya-city (JP); Toshio Harada, Nagoya-city (JP); Satoru Yamaguchi, Anjo-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-City (JP)

(21) Appl. No.: 11/181,025

(22) Filed: Jul. 14, 2005

(30) Foreign Application Priority Data
Jul. 16, 2004 (JP) 2004-210291
May 10, 2005 (JP) 2005-137566

(51) Int. Cl. B29C 47/00; B29C 47/12; B29C 47/38

(52) U.S. Cl. 264/177.12; 264/211.12; 264/211.21; 264/211.11; 425/377; 425/315

(57) ABSTRACT

An extrusion molding apparatus and an extrusion molding method is provided that permits deformation of molded body to be prevented and a sound extrusion molded body to be obtained even in the case where a soft extrusion molded body having low rigidity in a direction perpendicular to extrusion direction is molded.

An extrusion molding apparatus 1 comprises a screw extruder 12 that kneads a molding raw material 80 and extrudes an extrusion molded body 8 from a molding die 11, and a conveying apparatus 3 that supports said extrusion molded body 8 extruded continuously from the screw extruder 12 and conveys same in the extrusion direction. The screw extruder 12 has an inclination angle θ between the extrusion axis A and horizontal axis H in the range of 15° to 85°. The conveying apparatus 3 is constructed so as to move a reception stage 32 that supports said extrusion molded body 8 extruded along said extrusion axis A on the outer circumferential surface thereof, generally in parallel to said extrusion axis A. The inclination angle θ is preferably in the range of 30° to 75°.

### BACKGROUND OF THE INVENTION

1. Field of the Invention

The present invention relates to an extrusion molding apparatus and an extrusion molding method for molding an easily deformable extrusion molded body such as ceramic honeycomb structure.

2. Description of the Related Art

As a catalyst carrier used, for example, in an exhaust purifying apparatus for an automobile vehicle, as shown in FIG. 13, a ceramic molded body 8, of a honeycomb structure, is used. In the body partition walls 81 for partitioning a multiplicity of cells 88 communicating in axial direction, are arranged in honeycomb shape. Such a ceramic molded body 8 is generally manufactured by continuously extruding ceramic material consisting of a kneaded clay-like material and, after cutting the extruded material into unit lengths, drying and firing the extruded product.

In recent years, as improvements in product performance are required, it is strongly required to manufacture the above described molded body 8 with thinner partition walls 81. However, as the walls become thinner, the rigidity of the molded body immediately after extrusion is significantly decreased especially in the direction perpendicular to the axial direction, and in some cases, the molded body may deform due to its own weight and may not provide a successful product. This problem becomes particularly evident and pronounced in the case of honeycomb structure with ultra-thin walled partition where the thickness of partition walls is as small as 125 μm or less.

Demand for a ceramic molded body of honeycomb structure as described above is now increasing not only as a catalyst carrier in an exhaust gas purifying system in an automobile, but also as a substrate for collecting diesel particulates in an automobile vehicle. A ceramic molded body for collecting diesel particulates is constructed by plugging cells on both end faces in a checkered pattern and by composing the partition walls with a porous material so as to able to function as a filter.

When used as a substrate for collecting diesel particulates, a significantly larger body size is required for the ceramic molded body than is required when used simply as a catalyst carrier. For example, a volume capacity of about 2 liters is generally required for a passenger car, and volume capacity of about 6 liters to 15 liters is required for trucks of medium to large sizes. Thus, an increase in the weight is significant for a substrate for collecting diesel particulates due to the increases in volume and diameter, as well as an increase in thickness of partition walls, up to 250 to 350 μm, in order to satisfactorily filter and collect diesel particulates. Therefore, it becomes highly probable that the molded body immediately after extrusion may deform due to its own weight.

In order to resolve this problem, a method is proposed in horizontal extrusion process for producing a hexagonal honeycomb structure by extrusion in horizontal direction, in which the extrusion process is implemented such that the c-axis parallel to two sides of each hexagon is directed nearly in vertical direction (see Japanese Unexamined Patent Publication No. 2000-167818). This method, although effective, cannot be considered to be satisfactory as a further increase in size and a further reduction of wall thickness is needed.

In vertical extrusion process in which extrusion process is implemented in a vertically downward direction, it is difficult to support the outer circumferential surface during extrusion. The operation of supporting at the front end and cutting in unit length also becomes complicated, and efficiency is thereby lowered.

The problems associated with the lowering of rigidity of extrusion molded body are not limited to extrusion molding of ceramic molded body of honeycomb structure as described above, but are common to all molding of soft extrusion molded bodies that can deform due to the weight.

It is an object of the present invention to resolve the above problem associated with the prior art and to provide an extrusion molding apparatus and an extrusion molding method which, when molding a soft extrusion molded body with low rigidity in the direction perpendicular to the extruding direction, prevents such deformation and permits a sound extrusion molded body to be obtained.

### SUMMARY OF THE INVENTION

In accordance with a first invention, there is provided an extrusion molding apparatus comprising a screw extruder which kneads the raw material for molding and extrudes the kneaded material from a molding die to form an extrusion molded body, and a conveying apparatus for supporting and conveying, in the extrusion direction, said extrusion molded body continuously extruded from the screw extruder:
characterized in that the inclination angle θ between the extrusion axis and the horizontal axis of said screw extruder is in the range of 15° to 85°,
and that said conveying apparatus is constructed such that the reception stage for supporting said extrusion molded body extruded along said extrusion axis on outer circumferential surface, is moved generally in parallel to said extrusion axis.

In the extrusion molding apparatus according to the present invention, the screw extruder is disposed obliquely such that the inclination angle θ is in the above specified range, and the reception stage of said conveying apparatus is provided movably in oblique direction along said extrusion axis. Thus, the conveying apparatus supports and moves forward the extrusion molded body continuously extruded from said screw extruder on outer circumferential surface with said reception stage. Thus, as compared to conventional horizontal extrusion process in which extrusion is performed along a horizontal axis, the deformation force exerted to the extrusion molded body can be decreased and deformation can be prevented.

Specifically, the deformation force for deforming the extrusion molded body is mainly produced as a reaction to the weight when the extrusion molded body is supported at an outer circumferential surface by the reception stage etc. With the extrusion molding apparatus of the invention, by providing the inclination angle θ, the reaction from the reception stage can be decreased as compared to conventional horizontal extrusion process. Therefore, even if the extruded molded body is a soft molding that may collapse due to its own weight when placed with its axis in horizontal direction, the extrusion molded body can be conveyed without deformation using the extrusion molding apparatus of the invention.

The extrusion molded body is supported by the reception stage on the outer circumferential surface. Thus, when the extrusion molded body continuously extruded is cut in unit length, the extrusion molded body continues to be supported on the outer circumferential surface, so that cutting process can be performed stably.

Therefore, in accordance with the present invention, an extrusion molding apparatus can be provided which permits, even when a soft extrusion molded body having low rigidity in the direction perpendicular to the extrusion direction is molded, such deformation to be prevented and a sound extrusion molded body to be obtained.

In accordance with a second invention, there is provided an extrusion molding method for molding an extrusion molded body using an extrusion molding apparatus comprising a screw extruder which kneads the raw material for molding and extrudes the kneaded material from a molding die to form an extrusion molded body, and a conveying apparatus for supporting and conveying in extrusion direction said extrusion molded body continuously extruded from the screw extruder:
characterized in that the screw extruder is tilted such that the inclination angle θ between the extrusion axis and the horizontal axis is in the range of 15° to 85°, and that said conveying apparatus supports said extrusion molded body extruded along said extrusion axis on outer circumferential surface by a reception stage, and moves it generally in parallel to said extrusion axis.

In the extrusion molding method according to the present invention, a screw extruder disposed obliquely such that the inclination angle θ is in the range specified above, and a conveying apparatus provided with a reception stage capable of being moved obliquely along the extrusion axis, are used. Thus, the extrusion molded body extruded continuously from the screw extruder is supported on the outer circumferential surface and is moved forward by the reception stage.

Thus, the deformation force exerted on the extrusion molded body can be decreased as compared to prior art, and deformation can be prevented.

### BRIEF DESCRIPTION OF THE DRAWINGS

FIG. 1 is an explanatory view showing the construction of an extrusion molding apparatus in Example 1;

FIG. 2 is an explanatory view showing the interconnection between the conveying apparatus and a secondary conveying apparatus in Example 1 as seen in the direction of arrow X in FIG. 1;

FIG. 3 is an explanatory view showing the process in the midway of extrusion molding in Example 1;

FIG. 4 is an explanatory view showing extrusion molded body after cutting in Example 1;

FIG. 5 is an explanatory view showing the cut unit molded body abutting against the end surface reception stage;

FIG. 6 is an explanatory view showing the construction of an extrusion molding apparatus in Example 2;

FIG. 7 is an explanatory view showing the construction of an extrusion molding apparatus in Example 3;

FIG. 8 is an explanatory view showing a rotated downender of the extrusion molding apparatus in Example 3;

FIG. 9 is an explanatory view showing the construction of the upstream portion of the extrusion molding apparatus in Example 1 to 3;

FIG. 10 is an explanatory view showing the construction of an extrusion molding apparatus in Comparative example 1;

FIG. 11 is an explanatory view showing the sectional shape of the extrusion molded body in Example 1;

FIG. 12 is an explanatory view showing the sectional shape of the extrusion molded body in Comparative example 1; and

FIG. 13 is an explanatory view showing a honeycomb molded body in a prior example.

### DESCRIPTION OF THE PREFERRED EMBODIMENTS

In the above-described first and second inventions, the inclination angle θ is in the range of 15° to 85°. If the inclination angle θ is less than 15°, the effect of providing such an inclination angle cannot be sufficiently obtained. If the inclination angle exceeds 85°, the reaction when the extrusion molded body is supported on the outer circumferential surface is too small to obtain a stable support.

Thus, preferably, the inclination angle θ is in the range of 30° to 75°.

In the above-described first invention, the conveying apparatus comprises a conveyor with a conveying surface for placing the reception stage provided generally in parallel to the extrusion axis, and the conveyor is provided with a plurality of stoppers, for supporting the reception stage on the front end-face thereof in the moving direction, preferably constructed such that the reception stages successively supplied to the conveyor are successively supported by the stoppers to be moved forward. In this case, a plurality of reception stages can be successively moved forward at predetermined intervals, and the extrusion molded bodies can be stably supported.

The conveying apparatus also comprises a cutting device for cutting the extrusion molded body moving forward on the conveying apparatus in a specified length to form unit molded body, and one or plural reception stages are preferably disposed for each unit molded body. In this case, the extrusion molded body can be cut in unit lengths while being supported by one or plural reception stages so that stable cutting operation can be realized.

When the conveying apparatus comprises the above-described conveyor, the conveyor is preferably constructed such that conveying speed on the downstream side can be different from the conveying speed on the upstream side. With such construction, it is possible to separate the unit molded body cut by the cutting device from the lengthy extrusion molded body being extruded. It is also easy to slow down the conveying speed for changing to another direction. This increases the conveying capability for the unit molded bodies and facilitates a change in conveying direction.

It is also preferable that the conveying apparatus be interconnected with a secondary conveying apparatus for conveying the unit molded body in a direction different from the extrusion axis as it is supported at the axial end-face by the end-face reception stage. In this case, the unit molded body can be supported in an axial direction in which it is relatively rigid, and can be stably conveyed in a desired direction. Support by the end-face reception stage may be used in conjunction with support by the prior reception stage. Alternatively, support by the prior reception stage may be terminated and the unit molded body may be supported only by the end-face reception stage.

It is also preferable that a downender be disposed between the conveying apparatus and the secondary conveying apparatus for turning the axis of the unit molded body that is abutted against the end-face reception stage in generally vertical direction with the end-face reception stage facing downward. In this case, presence of the downender facilitates turning of the axis of the unit molded body in vertical direction.

It is also preferable that the extrusion molded body be a ceramic molded body using ceramic material as molding material. An extrusion molded body using ceramic material is very liable to be deformed immediately after extrusion. Therefore, above-described operative effect of the invention is particularly evident in such a case.

As the ceramic material, various raw materials, such as cordielite raw material that produces cordielite after firing, mullite raw material that produces mullite after firing, alumina raw material, silicon carbide raw material, silicon nitride raw material, etc can be used.

The extrusion molded body is preferably a honeycomb structure having partition walls arranged in a polygonal lattice pattern so as to provide a multiplicity of cells. When such a honeycomb structure is molded, it is required to maintain the lattice shape. As the partition wall becomes thinner, the wall is likely to be deformed, and therefore, the operative effect described above becomes more effective.

In the honeycomb structure as described above, the thickness of partition walls is preferably 125 μm or less. In this case, when it is used as a catalyst carrier in an exhaust gas purifying apparatus in an automobile, it can rapidly activate the carried catalyst and can improve the performance of the exhaust gas purifying apparatus. When the thickness of partition walls is preferably 125 μm or less, the structure is easily deformed, so that the operative effect of the first and the second inventions as described above becomes more effective. The lower bound of the thickness of partition walls is about 35 μm, based on the fluidity of clay material and extrusion pressure in the process of extruding clay-like ceramic material from a molding die, and constraints such as the strength of the molding die to withstand the pressure.

As the polygonal lattice, various forms are available such as triangular lattice, rectangular lattice, hexagonal lattice, and the like.

The honeycomb structure is preferably 300 mm or more in diameter. In this case, when it is used as a substrate for collecting diesel particulates in an automobile, a sufficient function for collecting particulates can be achieved. When such a honeycomb structure is to be molded, it is required to maintain the lattice shape. As the structure becomes larger, the partition walls are more likely to be deformed. In particular, when the diameter is 300 mm or more, the lattice is easily deformed, and therefore, the operative effect of the first and the second inventions becomes more effective.

### EXAMPLE 1

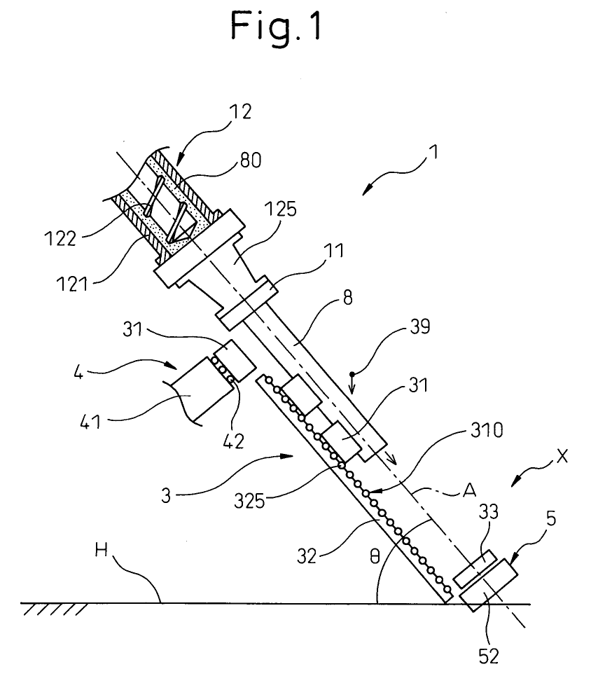

An extrusion molding apparatus and an extrusion molding method according to an Example of the present invention will be described below with reference to FIGS. 1 to 5.

The extrusion molding apparatus 1 of the present Example comprises, as shown in FIG. 1, a screw extruder 12 that kneads the molding raw material 80 and extrudes an extrusion molded body 8 from a molding die 11, and a conveying apparatus 3 that supports the extrusion molded body 8 continuously extruded from the screw extruder 12, and conveys same in extrusion direction.

The screw extruder 12 has an inclination angle θ, between the extrusion axis A and the horizontal axis H, in the range of 15° to 85°. The conveying apparatus 3 is constructed so as to move a reception stage 31, which supports the extrusion molded body 8 extruded along the extrusion axis A on the outer circumferential surface, generally in parallel to the extrusion axis A.

This will be described in more detail below.

The screw extruder 12 constituting the extrusion molding apparatus 1 of the present Example has, as shown in FIG. 1, an extrusion screw 122 built into a tubular casing 121, and has a molding die 11 provided via a resistance tube 125 at its distal end. The screw extruder 12 may be composed of plural screw extruders.

In the present Example, the extrusion axis A of the screw extruder, that is, the center axis of the screw extruder 12 and the molding die 11, is inclined relative to the horizontal axis H. The inclination angle θ is set to 45° in the present Example.

The conveying apparatus 3 is provided in the lower portion in front of the screw extruder 12. The conveying apparatus 3 of the present Example has a conveyor 32, as shown in FIG. 1, provided with the conveying surface 310 for placing a reception stage 31 generally in parallel to the extrusion axis A. In the present Example, a roller conveyor is adopted as the conveyor 32, and is constructed so as to move the reception stage 31 progressively forward by means of plural driving rollers 325. The conveyor 32 is constructed such that conveying speed can be partially varied and, as will be described later, is actually set such that the conveying speed can be varied depending on the position of a cut unit molded body 8a.

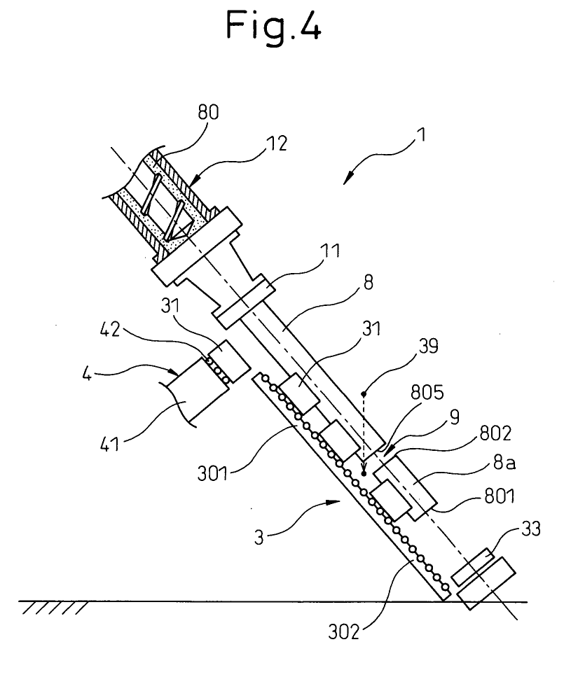

Also, as shown in the same Figure, the conveying apparatus 3 has a cutting device 39 for cutting the extrusion molded body 8 moved on the conveyor 32 into a unit molded body 8a (FIG. 4). The conveying apparatus 3 is constructed such that one reception stage 31 is disposed for each unit molded body. The above-described cutting device 39 is one using a wire that is moved in cutting direction while the wire is run in an axial direction.

The reception stage 31 of the present Example is of generally rectangular parallelepiped in shape having a receiving surface (not shown) formed on top face by boring in circular arc along the outer circumferential shape of the cylindrical extrusion molded body.

The upstream end of the conveyor 32 is disposed with a gap to the molding die 11 at the front end of the screw extruder 12. In this gap, a reception stage supplying apparatus 4 is provided for supplying the reception stages 31 successively. The reception stage supply apparatus 4 has a reception stage holding section 41 movable in up/down direction, and the reception stage holding section 41 comprises a roller 42 for moving forward the placed reception stage 31. The reception stage supplying apparatus 4 successively elevates the reception stage 31 that is fed through a reception stage supplying route (not shown), and abuts it to the outer circumferential surface of the extrusion molded body 8 without imparting a shock and, then, the roller 42 moves the reception stage 31 forward with the advancing extrusion molded body 8, and transfers it to the conveyor 32.

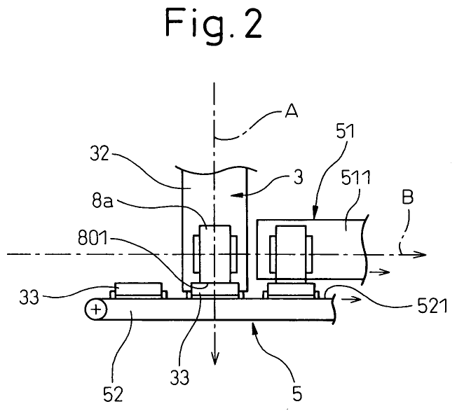

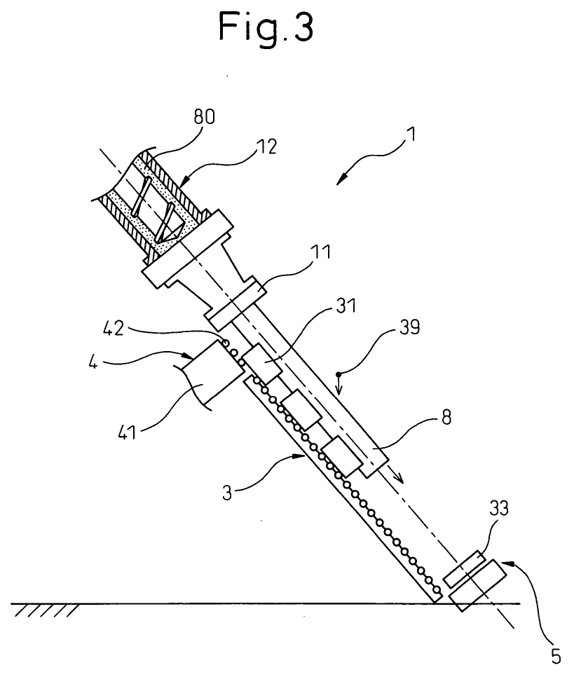

As shown in FIGS. 1 and 2, the conveying apparatus 3 is interconnected with a secondary conveying apparatus 5 that conveys the unit molded body 8a in a conveying direction B different from the extrusion axis A with the unit molded body 8a (see FIG. 2, FIGS. 3 to 5) supported at the axial front end-face 801 by an end-face reception stage 33.

The secondary conveying apparatus 5 is constructed, as shown in FIG. 2, as a combination of two conveyors so as to convey the unit molded body 8a in a horizontal conveying direction B perpendicular to the extrusion axis A that is the conveying direction of the conveying apparatus 3.

Thus, the secondary conveying apparatus 5 comprises a first conveyor 51 that receives the reception stage 31 conveyed by the conveying apparatus 3 as it is and changes the conveying direction and a second conveyor 52 that receives a flat plate-shaped end-face reception stage 33 successively supplied by an end-face reception stage supplying apparatus (not shown) and supports and moves it forward in the conveying direction B. The conveying surfaces 511, 521 are disposed, as shown in FIG. 2, so as to be perpendicular to each other, and move in synchronism in the conveying direction B.

Next, the method of carrying out extrusion molding by using the extrusion molding apparatus 1 having the above-described construction will be described.

The extrusion molded body 8 molded in the present Example is a ceramic molding using a ceramic material as the raw material for molding, as shown in the above-described FIG. 13, that is a honeycomb structure having partition walls 81 arranged in the shape of hexagonal lattice to provide a multiplicity of cells in a cylinder-shaped skin section 82. The honeycomb structure in the shape of hexagonal lattice is more likely to be deformed as compared to honeycomb structure in the shape of triangular lattice or rectangular lattice. It is to be understood that the partition walls 81 can be modified to triangular lattice, rectangular lattice, or another polygonal lattice.

The thickness of the partition wall 81 of the extrusion molded body 8 in the present Example is as small as 60 μm.

When molding the extrusion molded body 8, a ceramic material was first provided as the raw material 80 for molding the extrusion molded body 8, as shown in FIG. 1. The ceramic material used was powder to be formed into cordielite and was mixed with water in a clay-like form.

This raw material 80 for molding is kneaded and moved forward by the above described screw extruder 12 to be extruded from the molding die 11.

The extrusion molded body 8 is first supported, as shown in FIG. 3, on the lower portion of the outer circumferential surface by the reception stage 31 supplied from the reception stage supplying apparatus 4. The extrusion molded body 8 and the reception stage 31 moves forward synchronously, and the reception stage 31 is transferred to the conveyor 32. Then, supported by the reception stage 31 moving on the conveyor 32, the extrusion molded body 8 moves forward at a constant speed.

Then, as shown in FIG. 4, every time the extrusion molded body 8 moves forward a predetermined distance, the above-described cutting device 39 is used to cut a unit molded body 8a of predetermined length. At this time, the cut unit molded body 8a is placed on one reception stage 31. The conveyor 32 of the present Example is constructed such that, immediately after cutting, speed on the downstream side is increased as compared to that on the upstream side. Therefore, a gap is provided between the rear end-face 802 of the unit molded body 8a and the front end 805 of the uncut extrusion molded body 8, and this gap increases as the unit molded body 8a moves forward.

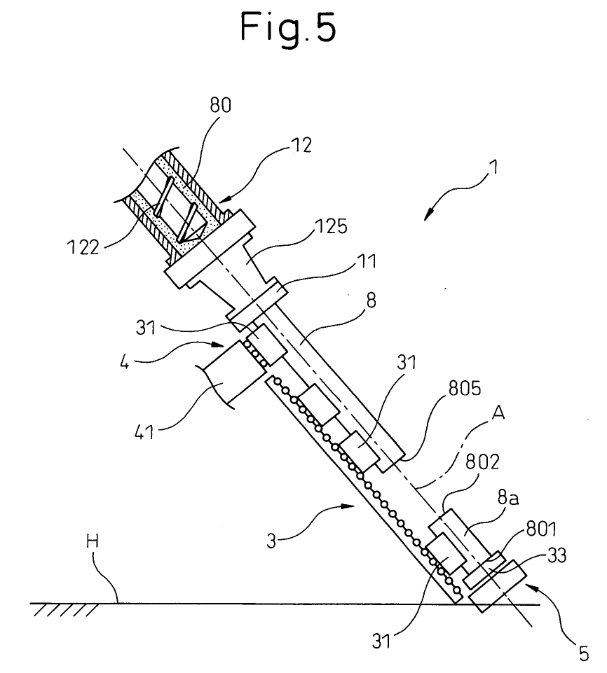

And as shown in FIG. 5, before the unit molded body 8a abuts against the end-face reception stage 33, the conveying speed on the downstream side can be lowered such that the unit molded body 8a abuts against the end-face reception stage 33 with substantially no shock. Thereafter, as shown in FIG. 2, while supported both by the end-face reception stage 33 and by the reception stage 31, the unit molded body 8a is conveyed in the conveying direction B by the first conveyor 51 and the second conveyor 52 of the secondary conveying apparatus 5.

Next, the operative effect of the present Example will be described.

In the present Example, as described above, an extrusion molding apparatus 1 is used in which the screw extruder 12 is disposed obliquely such that the inclination angle θ takes a specified value, and the reception stage 31 of the conveying apparatus 3 can move obliquely along the extrusion axis A. The extrusion molded body 8 continuously extruded from the screw extruder 12 is supported on the outer circumferential surface by the reception stage 31 and moves forward in this state. In this way, the reaction force imparted from the reception stage to the extrusion molded body 8 can be decreased as compared to the case of conventional horizontal extrusion process in which extrusion molding is performed along horizontal axis. Therefore, a deforming force imparted to the extrusion molded body 8 can be reduced and deformation can be prevented.

The extrusion molded body 8 is conveyed with the outer circumferential surface supported by the reception stage 31. Therefore, when the extrusion molded body 8 that is extruded continuously is cut into unit lengths, the molded body can be maintained at least in the state supported on the outer circumferential surface so that stable cutting operation can be achieved. Thereafter, in the present Example, when the unit molded body 8a is conveyed in the direction different from the extrusion direction, the unit molded body 8a is supported both by the reception stage 31 and by the end-face reception stage 33, so that it can be conveyed more stably.

In the case where an extrusion molded body 8 for collecting diesel particulates is to be obtained using the extrusion molding apparatus 1 of the present Example, although the construction of the apparatus needs not be modified, the diameter of the molding die 11 of the screw extruder 12 is preferably set to 1.15 times or more of the diameter of the extrusion molded body to be obtained.

### EXAMPLE 2

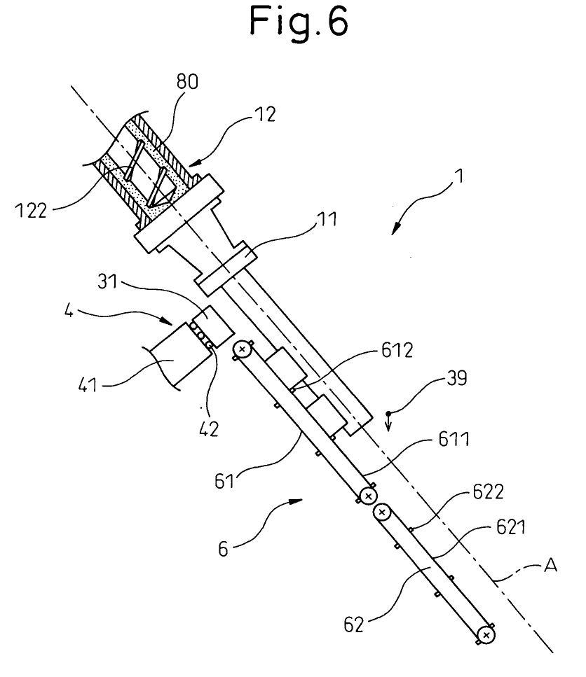

In the present Example, as shown in FIG. 6, the construction of the conveying apparatus 3 is modified from the extrusion molding apparatus 1 in Example 1.

Thus, the conveying apparatus 6 of the present Example adopts belt conveyors 61, 62 in place of the above-described conveyor 32 consisting of roller conveyors. Each of the belt conveyors 61, 62 has conveying surface 611, 621 for placing the reception stage 31 provided generally in parallel to the extrusion axis A. Plural stoppers 612, 622 are provided on the conveying surfaces 611, 621 for supporting the reception stage 31 at the front end-face in moving direction, and are constructed such that the reception stages 31 successively supplied to the conveyor can be successively supported by the stoppers 612, 622, and can be moved forward.

The belt conveyor 61 on the upstream side and the belt conveyor 62 on the downstream side are constructed so as to be able to change conveying speed. More specifically, the belt conveyor 61 on the upstream side is kept at a constant speed, and the belt conveyor 62 on the downstream side is constructed such that it is accelerated when the reception stage 31 loading the unit molded body after cutting is transferred, and is decelerated before the reception stage 31 loading the unit molded body thereon is transferred to the conveying equipment on the downstream side.

The other constructions are the same as in Example 1, and same operative effect as in Example 1 can be obtained.

### EXAMPLE 3

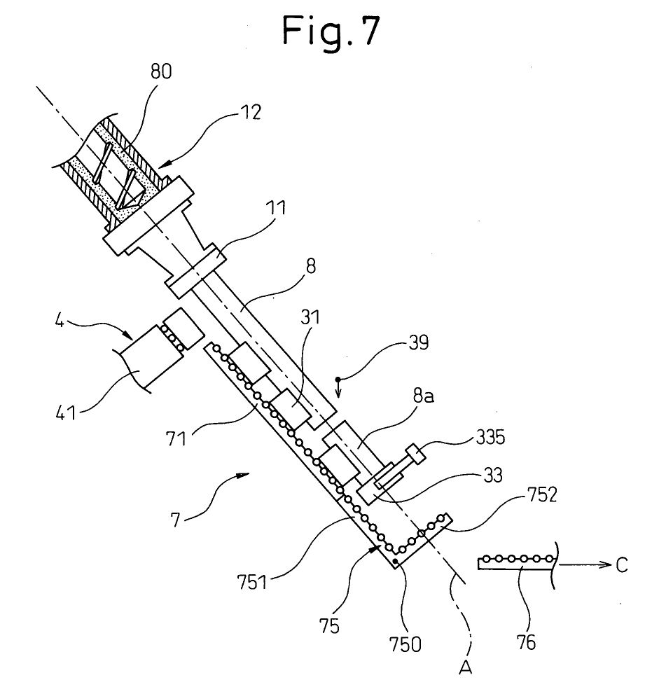

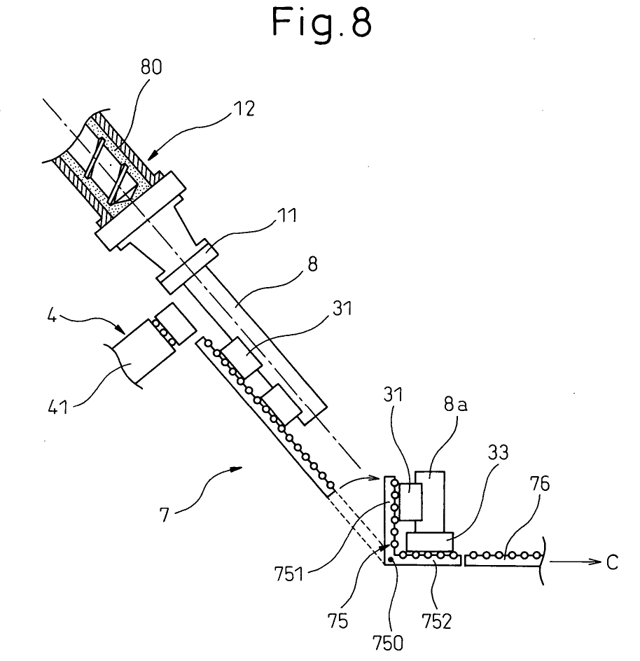

In the present Example, as shown in FIGS. 7 and 8, the construction of the conveying apparatus 3 in Example 1 is altered.

Thus, the conveying apparatus 7 in the present Example adopts, in place of the conveyor 32 consisting of simple roller conveyors as described above, a conveyor 71 having a downender 75 interconnected at the lowest stage.

The downender 75 exhibits L-shape in section with a first surface 751 and the second surface 752 disposed generally perpendicular to each other, and is constructed rotatably between the position in which the conveying plane of the first surface 751 is in parallel to the extrusion axis A (FIG. 7) and the position in which the second surface 752 is horizontal (FIG. 8).

In the present Example, a secondary conveying apparatus 76 having conveying direction C in horizontal direction is connected downstream of the downender 75. In the state in which the second surface 752 of the downender 75 is horizontal, the conveying plane is coplanar with the conveying plane of the secondary conveying apparatus 76.

The other constructions are the same as in Example 1.

In the present Example, the end-face reception stage 33 having the cut unit molded body abutted at the front surface is supported by a reception stage transfer apparatus 335 and is led to the first surface 751 of the down ender 75. Immediately after the end-face reception stage 33 abuts against the second surface 752, the down ender 75 rotates so as to bring the second surface 752 into horizontal state, whereby the second surface 752 is interconnected with the secondary conveying apparatus 76. In this state, by moving the end-face reception stage 33 forward, the unit molded body 8a leaves the reception stage 31 and, supported by the end-face reception stage 33 in only the axial direction, is conveyed. On the other hand, the reception stage 31 is removed from the downender 75 by an unshown reception stage conveying apparatus.

Thus, in the present Example, the unit molded body 8a after cutting can be conveyed with its axis directed vertically and supported only on the lower end-face. Therefore, the unit molded body 8a can be conveyed more stably, and the effect on the prevention of deformation of the unit molded body 8a can be further increased. Otherwise, same operative effect can be obtained as in Example 1.

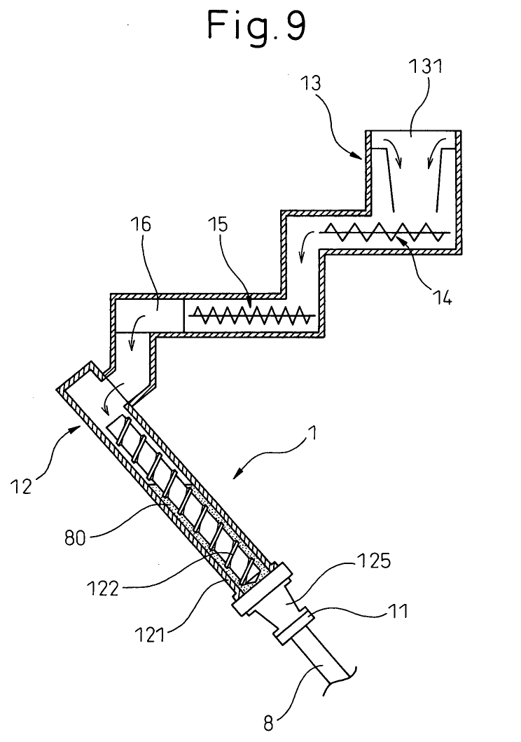

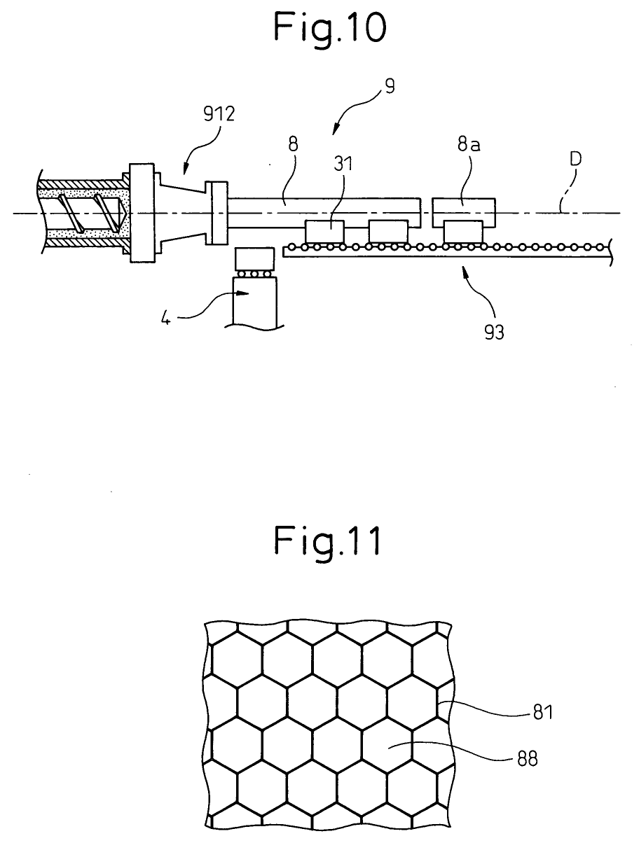

The extrusion molding apparatus 1 in Example 1 to 3 has a portion for supplying the molding raw material 80 in clay-like state on the upstream side of the screw extruder 12. This portion will be described below with reference to FIG. 9.

As shown in FIG. 9, the upstream side of the screw extruder 12 comprises a molding raw material loading section 13, a coarse kneader 14, a fine kneader 15 in this order from upstream side. In the above construction, powder mixture consisting of ceramic material powder containing specified amount of water mixed with organic compound such as a binder, a lubricant, etc., is loaded into a loading port 131 of the molding raw material loading section, and the powder mixture is continuously kneaded in the course of passage through the coarse kneader 14 and the fine kneader 15 and is converted to clay-like state.

Then, the air incorporated into the clay-like raw material during the kneading is degassed in a vacuum degassing chamber 16 provided in the rear portion of the fine kneader 15, and the clay is fed into the screw extruder 12 in a completely degassed and packed state.

Kneading is performed in two stage of coarse kneading and fine kneading in the present Example. Depending upon the properties of the raw material, single stage kneading or multiple stage kneading may be used.

Although the kneaders are arranged horizontally in the present Example, they may be arranged vertically.

A plural vacuum degassing chambers may be provided, one after each kneader.

### COMPARATIVE EXAMPLE 1

In the present Comparative example, extrusion molding is performed using an extrusion molding apparatus 9 comprising a screw extruder 912 with extrusion axis D in horizontal direction and a conveying apparatus 93, as comparative example compared to Example 1.

Here, an observation was made as to whether or not the deformation took place during conveyance of the extrusion molded body molded in Example 1 and the extrusion molded body molded in Comparative example 1.

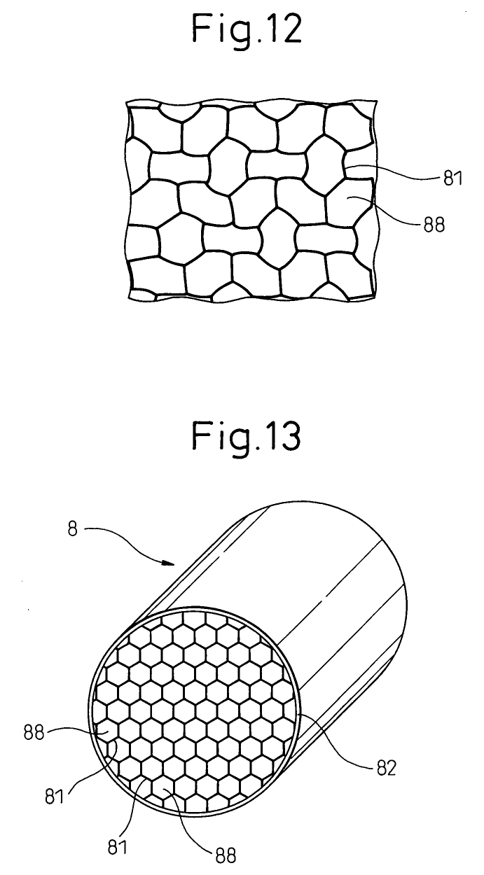

FIG. 11 is a sectional view showing the sectional shape of the partition wall 81 of the extrusion molded body molded in Example 1. FIG. 12 is a sectional view showing the sectional shape of the partition wall 81 of the extrusion molded body molded in Comparative example 1.

As can be seen from these Figures, it is difficult, at least in the case of ultra-thin walled honeycomb structure with thickness of the partition wall 81 of 125 μm, to mold by the horizontal extrusion molding method in which extrusion direction is horizontal (Comparative example 1) without giving rise to deformation during conveyance. This deformation can be prevented by tilting the extrusion axis A at an inclination angle relative to horizontal axis as described above (Example 1).

What is claimed is:

1. An extrusion molding apparatus comprising a screw extruder that kneads a molding raw material and extrudes an extrusion molded body from a molding die, and a conveying apparatus that supports said extrusion molded body extruded continuously from the screw extruder and conveys same in the extrusion direction:
characterized in that said screw extruder has an inclination angle θ between the extrusion axis and horizontal axis in the range of 15° to 85°;
and that said conveying apparatus is constructed so as to move a reception stage that supports said extrusion molded body extruded along said extrusion axis on the outer circumferential surface thereof, generally in parallel to said extrusion axis.

2. An extrusion molding apparatus according to claim 1, wherein said inclination angle θ in the range of 30° to 75°.

3. An extrusion molding apparatus according to claim 1, wherein said conveying apparatus has a cutting device for cutting said extrusion molded body moving on the conveying apparatus to a predetermined length to form a unit molded body, and one or plural said reception stages are disposed for each said unit molded body.

4. An extrusion molding apparatus according to claim 3, wherein said conveying apparatus is connected to a secondary conveying apparatus that conveys said unit molded body with said unit molded body supported at its front end-face by an end-face reception stage in a direction different from said extrusion axis.

5. An extrusion molding apparatus according to claim 4, wherein a downender is disposed between said conveying apparatus and said secondary conveying apparatus, for turning said unit molded body abutted against said end-face reception stage into a position in which said end-face reception stage lies underneath and the axis is directed in generally vertical direction.

6. An extrusion molding apparatus according to claim 1, wherein said extrusion molded body is a ceramic molded body using ceramic material as said molding raw material.

7. An extrusion molding apparatus according to claim 1, wherein said extrusion molded body is a honeycomb structure with partition walls arranged in the shape of polygonal lattice so as to provide a multiplicity of cells.

8. An extrusion molding apparatus according to claim 7, wherein thickness of said partition wall of said honeycomb structure is 125 μm or less.

9. An extrusion molding apparatus according to claim 7, wherein diameter of said honeycomb structure is 300 mm or more.

10. An extrusion molding method for molding an extrusion molded body using an extrusion molding apparatus comprising a screw extruder that kneads a molding raw material and extrudes an extrusion molded body from a molding die, and a conveying apparatus that supports said extrusion molded body extruded continuously from the screw extruder and conveys same in the extrusion direction:
characterized in that said screw extruder is tilted so as to have an inclination angle θ between the extrusion axis and horizontal axis in the range of 15° to 85°, and that said conveying apparatus is constructed so as to move a reception stage that supports said extrusion molded body extruded along said extrusion axis on the outer circumferential surface thereof, generally in parallel to said extrusion axis.

11. An extrusion molding method according to claim 10, wherein said inclination angle θ is in the range of 30° to 75°.

12. An extrusion molding method according to claim 10, wherein said extrusion molded body is a ceramic molded body using ceramic material as said molding raw material.

13. An extrusion molding method according to claim 10, wherein said extrusion molded body is a honeycomb structure with partition walls arranged in the shape of polygonal lattice so as to provide a multiplicity of cells.

14. An extrusion molding method according to claim 13, wherein thickness of said partition wall of said honeycomb structure is 125 μm or less.

15. An extrusion molding method according to claim 13, wherein diameter of said honeycomb structure is 300 mm or more.
